(19) United States
(12) Patent Application Publication
(10) Pub. No.: US 2025/0066059 A1
(43) Pub. Date: Feb. 27, 2025

(54) FAULT DETECTION CLAMP FOR LABELLING SYSTEM

(71) Applicant: NIAGARA BOTTLING, LLC, Diamond Bar, CA (US)

(72) Inventors: Billy Cubbage, Diamond Bar, CA (US); Michael Wingo, Diamond Bar, CA (US); Steve Gonzalez, Diamond Bar, CA (US); Efrain Flores, Diamond Bar, CA (US); Steve Ragas, Diamond Bar, CA (US); John Post, Diamond Bar, CA (US)

(21) Appl. No.: 18/812,496

(22) Filed: Aug. 22, 2024

Related U.S. Application Data
(60) Provisional application No. 63/578,900, filed on Aug. 25, 2023.

(51) Int. Cl. B65C 9/42; B65C 3/08; B65C 9/18; B65C 9/40

(52) U.S. Cl. CPC B65C 9/42; B65C 3/08; B65C 9/1892; B65C 2009/404

(57) ABSTRACT

A storage unit for a labelling system may include a carrier configured to receive a reel supporting the label material. A storage unit may include a fault detection system configured to selectively prevent the label material from travelling along the conveying path, the fault detection system including: a sensor configured to detect whether the label material is present in a detection zone of the conveying path; and a clamp assembly downstream of the sensor along the conveying path, the clamp assembly being configured to clamp the label material to prevent the label material from travelling along the conveying path in response to the sensor detecting that the label material is not present in the detection zone.

### CROSS-REFERENCE TO RELATED APPLICATIONS

This application claims priority to U.S. Provisional Patent Application No. 63/578,900, filed Aug. 25, 2023, the entire contents of which is hereby incorporated by reference

### FIELD

The present disclosure relates to systems and methods for providing a label to be attached to a container.

### BACKGROUND

Labels are used on product containers to convey product information such as, for example, date codes indicative of a product manufacturing date, a product expiration date, and/or a “best by” date. Labels may be self-adherent, or an additional adhesive may be applied. In some embodiments, printed labels may be stored on a reel and supplied to a label applicator by a storage system.

### SUMMARY

In one embodiment, the disclosure provides a storage unit for a labelling system, the labelling system configured to move a label material along a conveying path and apply the label material to a plurality of bottles, the storage unit including: a carrier configured to receive a reel supporting the label material; and a fault detection system configured to selectively prevent the label material from travelling along the conveying path, the fault detection system including: a sensor configured to detect whether the label material is present in a detection zone of the conveying path; and a clamp assembly downstream of the sensor along the conveying path, the clamp assembly being configured to clamp the label material to prevent the label material from travelling along the conveying path in response to the sensor detecting that the label material is not present in the detection zone.

In some aspects, the techniques described herein relate to a storage unit, wherein: the carrier is a first carrier and the reel is a first reel, and the storage unit further includes a second carrier configured to receive a second reel supporting the label material; the storage unit further includes a joining device configured to couple the label material of the first reel to the label material of the second reel.

In some aspects, the techniques described herein relate to a storage unit, wherein the sensor is positioned adjacent the joining device.

In some aspects, the techniques described herein relate to a storage unit, wherein a broken end of the label material is formed in response to the joining device failing to couple the label material of the first reel to the label material of the second reel, and wherein the clamp assembly is configured to clamp the label material before the broken end exits the storage unit along the conveying path.

In some aspects, the techniques described herein relate to a storage unit, wherein the clamp assembly includes a first clamp bar arranged in facing relationship with a second clamp bar, and wherein the first clamp bar is configured to move between a clamped position proximate the second clamp bar and an unclamped position distant from the second clamp bar.

In some aspects, the techniques described herein relate to a storage unit, wherein the clamp assembly further includes an actuator configured to move the first clamp bar between the clamped position and the unclamped position.

In some aspects, the techniques described herein relate to a storage unit, wherein the actuator includes a solenoid valve assembly.

In another embodiment, the disclosure provides a fault detection system for a labelling system, the labelling system including a storage unit, a buffering device, and a label applicator, the labelling system being configured to move a label material along a conveying path from the storage unit through the buffering device and to the label applicator, the label applicator being configured to apply the label material to a plurality of containers, the storage unit including a first carrier configured to receive a first reel supporting the label material, a second carrier configured to receive a second reel supporting the label material, and a joining device configured to couple the label material of the first reel to the label material of the second reel, the fault detection system including: a sensor configured to detect whether the label material is present in a detection zone of the conveying path; and a clamp assembly configured to clamp the label material to prevent the label material from travelling along the conveying path in response to the sensor detecting that the label material is not present in the detection zone of the conveying path.

In some aspects, the techniques described herein relate to a fault detection system, wherein the sensor is configured to be positioned adjacent the joining device.

In some aspects, the techniques described herein relate to a fault detection system, wherein the clamp assembly includes a first clamp bar arranged in facing relationship with a second clamp bar, and wherein the first clamp bar is configured to move between a clamped position proximate the second clamp bar and an unclamped position distant from the second clamp bar.

In some aspects, the techniques described herein relate to a fault detection system, wherein the clamp assembly further includes a bracket configured to support the first clamp bar and the second clamp bar on the storage unit.

In some aspects, the techniques described herein relate to a fault detection system, wherein the clamp assembly further includes an actuator configured to move the first clamp bar between the clamped position and the unclamped position.

In some aspects, the techniques described herein relate to a fault detection system, wherein the actuator includes a solenoid valve assembly.

In another embodiment, the disclosure provides a method of operating a labeling system configured to apply label material to containers, the method including: moving a label material along a conveying path from a storage unit, through a buffering device, and to a label applicator; applying the label material to the containers via the label applicator; detecting, via a sensor, whether the label material is present in a detection zone of the conveying path; and clamping, via a clamp assembly, the label material at a location downstream from the detection zone along the conveying path in response to detecting that the label material is not present in the detection zone.

In some aspects, the techniques described herein relate to a method, further including deactivating the label applicator in response to detecting that the label material is not present in the detection zone.

In some aspects, the techniques described herein relate to a method, further including releasing the label material from the clamp assembly in response to an operator generated deactivation signal.

In some aspects, the techniques described herein relate to a method, further including: attaching a first free end of the label material to a second free end of the label material while the clamp assembly remains released and the label applicator remains deactivated; and clamping the label material via the clamp assembly in response to an operator generated reactivation signal.

In some aspects, the techniques described herein relate to a method, further including releasing the label material from the clamp assembly in response to a fault clear signal.

In some aspects, the techniques described herein relate to a method, further including reactivating the label applicator in response to the fault clear signal.

In some aspects, the techniques described herein relate to a method, further including joining, via a joining device, the label material supplied from a first reel to the label material supplied from a second reel.

Other aspects of the disclosure will become apparent by consideration of the detailed description and accompanying drawings.

### BRIEF DESCRIPTION OF THE DRAWINGS

FIG. 1 illustrates a labelling system for applying labels to containers, such as bottles, the system including a storage unit, a buffering device, a label applicator, and a fault detection system.

FIG. 2 illustrates a portion of the labelling system of FIG. 1, including an alternate storage device, and label material following a conveying path through the labelling system.

FIG. 3 illustrates a sensor of the fault detection system of FIG. 1.

FIG. 4 illustrates a clamping device of the fault detection system of FIG. 1 from an upstream perspective.

FIG. 5 illustrates a bracket of the clamping device of FIG. 4.

FIG. 6 illustrates the clamping device of FIG. 4 from a downstream perspective.

FIG. 7 illustrates an actuator of the fault detection system of FIG. 1.

FIG. 8 illustrates an exemplary flow chart showing a method of operation of the fault detection system of FIG. 1.

FIG. 9A illustrates an exemplary display of the labelling system of FIG. 1, displaying information relating to a fault condition.

FIG. 9B illustrates another exemplary display of the labelling system of FIG. 1, displaying information relating to a fault condition.

FIG. 10 illustrates another exemplary portion of a display of the labelling system of FIG. 1, displaying an override option.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

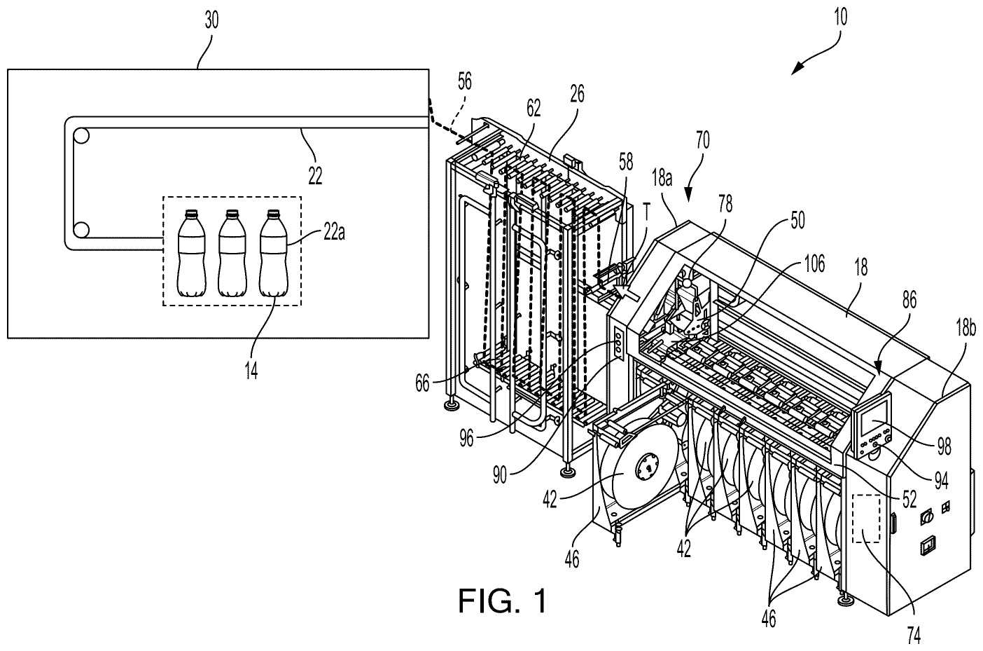

FIG. 1 illustrates a labelling system 10 for the labelling of containers 14 (for example, bottles). The labelling system 10 includes a storage unit 18 for label material 22, a buffering device 26, and a label applicator 30. Label material 22 is conveyed from the storage unit 18, through the buffering device 26, and supplied to the label applicator 30 which attaches the label material 22 to the containers 14. The label applicator 30 may include a cutting device which cuts the label material 22 to form individual labels 22a of the appropriate length. The labels 22a are then attached to the outer surface of the containers 14. In some embodiments, the labels 22a may be self-adhering, and the applicator 30 may include a separator that separates the labels 22a from a backing strip. In other embodiments, the labels 22a may be attached with additional adhesive applied to either the labels 22a or the containers 14, and the applicator 30 may include an adhesive applicator.

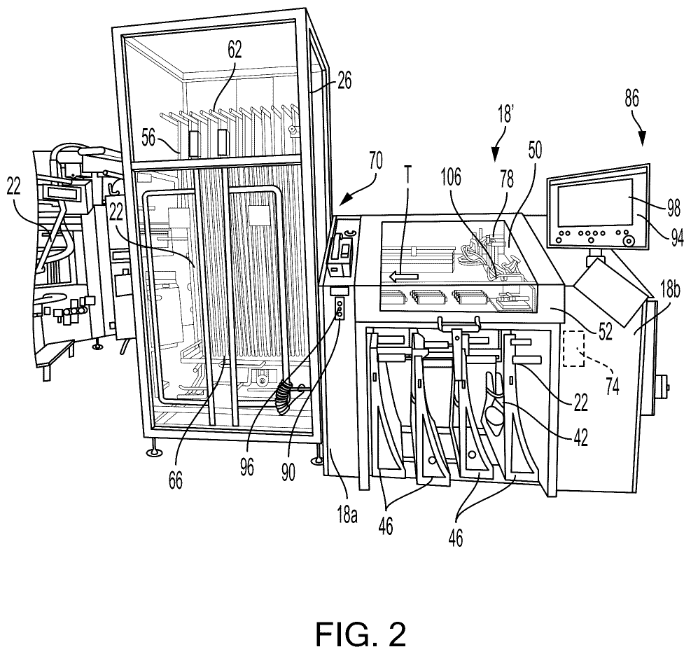

The storage unit 18 (also referred to herein as a multireel 18) receives a store of the label material 22. The label material 22 may be wound on a plurality of reels 42. The storage unit 18 includes a plurality of receiving units or carriers 46. Each carrier 46 may receive a reel 42 of label material 22. In the illustrated embodiment, the storage unit 18 includes eight of the carriers 46. In some embodiments, the storage unit 18 may include more of the carriers 46 or may include as few as two of the carriers 46 depending on the needs of the labelling system 10. FIG. 2 illustrates a storage unit 18′ with four carriers 46. Additionally, not all the carriers 46 may receive reels 42 of label material 22 depending on the situation. In some embodiments, the label material 22 includes a preprinted repeating pattern. In other embodiments, the label material 22 is blank and will be printed downstream of the storage unit 18.

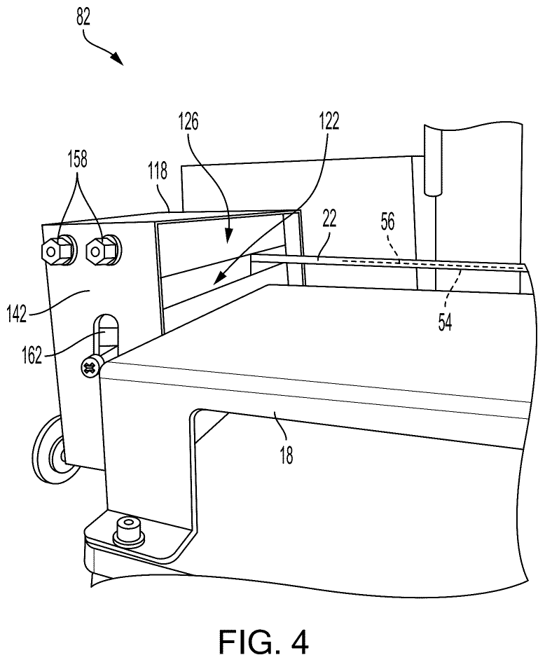

The storage unit 18 further includes a joining device 50. The joining device 50 may be an automatic splicer. When one of the reels 42 runs out of label material 22, the tail end of the strip of the label material 22 may be joined or spliced to the front end of the strip of label material 22 located on the adjacent reel 42. The splice may occur in a splice zone 106. In this way, the storage unit 18 can supply an ‘endless’ strip of label material 22 to the label applicator 30. The joining device 50 and the splice zone 106 are accessible by opening a door 52 of the storage unit 18. The label material 22 is unwound from the reels 42 by the storage unit 18 and is conveyed through the labelling system 10 in a conveying direction T along a conveying path 56. After passing through the joining device 50, the label material 22 exits the storage unit 18 along an exit portion 54 (FIG. 4) of the conveying path 56.

With continued reference to FIG. 1, the splicing operation performed by the joining device 50 may require that the speed of the storage unit 18 be decreased in order to securely splice the label material 22 from one reel 42 to the label material 22 from the next reel 42. To account for this, the labelling system 10 includes a buffering device 26 downstream from the storage unit 18 in the conveying direction T. The buffering device 26 is used to compensate for the differences in speed between the storage unit 18 and the label applicator 30 arising during the splicing operation and/or during other points in the operation of the labelling system 10. The buffering device 26 includes a primary roller 58 and a plurality of upper reversing shafts 62 and lower reversing shafts 66 around which the label material 22 is guided (shown in FIG. 2). The label material 22 may be conveyed from the storage unit 18 generally laterally and may wrap partially around the primary roller 58 to change direction and extend generally vertically. The label material 22 is then guided upwards and downwards by the plurality of reversing shafts 62, 66. The amount (e.g., the length) of the label material 22 stored inside the buffering device 26 can be varied by displacing the set of the upper reversing shafts 62 and/or the set of lower reversing shafts 66 towards or away from each other in a generally vertical direction. The buffering device 26 is arranged between the storage unit 18 and the label applicator 30 along the conveying path 56 and partially isolates the storage unit 18 from the label applicator 30 so that the reduced speed of label material 22 being conveyed from the storage unit 18 during the splicing operation does not impact the speed of label material 22 being supplied to the label applicator 30.

During a beginning of operation of the labelling system 10, the storage unit 18 may unwind the label material 22 from the reel 42 closest to a first end 18a of the storage unit 18. The joining device 50 is movable between the first end 18a and a second end 18b of the storage unit 18 generally opposite from the first end. As operation of the labelling system 10 continues and as the joining device 50 splices the label material 22 from each adjacent reel 42, the joining device 50 may move across the plurality of carriers 46 toward the second end 18b of the storage unit 18.

FIG. 2 illustrates the labelling system 10 including the storage unit 18′ having four of the carriers 46. The labelling system 10 is illustrated near an end of the labelling operation, where the reels 42 in the three carriers 46 nearer to the first end 18a have been emptied, and the storage unit 18′ is dispensing label material 22 from the reel 42 in the carrier 46 closest to the second end 18b. The joining device 50 is therefore positioned adjacent the second end 18b. The buffering device 26 is shown as loaded with label material 22 which continues along the conveying path 56 to the label applicator 30.

At times during operation of the labelling system 10, the joining device 50 may fail to securely splice the label material 22 from one reel 42 to the label material 22 from the next reel 42. At other times, the label material 22 may otherwise snap or break during the middle of a strip being unwound from the reels 42.

In some known configurations, when a failed splice (or break) occurs, the tail end or broken end of the label material 22 is conveyed along the conveying path 56 from the storage unit 18, through the buffering device 26, and is supplied to the label applicator 30, at which point the absence of label material 22 is detected, and the labelling system 10 is stopped. Once the labelling system 10 is stopped, an operator then must manually convey the beginning of the label material 22 from the next reel 42 (or the broken end of the label material 22 from the current reel 42) through the joining device 50, along the exit portion 54 of the conveying path 56 out the storage unit 18, wrap the label material 22 around the primary roller 58 of the buffering device 26, hand-wind the label material 22 over and under each of the reversing shafts 62, 66 of the buffering device 26, and then supply the label material 22 to the label applicator 30. Only once that is accomplished can the labelling system 10 be re-started and labelling of the containers 14 can continue. This process can be time-intensive and cause extended downtime of the labelling system 10 which decreases the efficiency of the labelling system 10.

Therefore, as seen in FIGS. 1 and 2, the illustrated labelling system 10 includes a fault detection system 70. The fault detection system 70 includes a control system 74, a sensor 78, and a clamping device 82 (FIG. 4). The control system 74 may be a common control system with the rest of the labelling system 10 or may be a separate control system 74 that may be in communication with a control system of the labelling system 10. The control system 74 receives input from the sensor 78 and may output a signal to the clamping device 82. The control system 74 may also be connected to a user interface 86 on the storage unit 18 to output information to the user interface 86. In some embodiments, the user interface 86 includes a display which may include one or more of a screen, a touchscreen, indicator light(s), speakers, etc. The user interface 86 may also include an input device which may include one or more of a keyboard, a touchscreen, button(s), microphones, etc. In some embodiments, the user interface 86 may include an electronic device such as a computer terminal, a mobile phone, a tablet, etc. that may be wirelessly connected to the control system 74. In the illustrated embodiment, the user interface 86 includes a first control panel 90 mounted on the first end 18a of the storage unit 18 (near the exit portion 54 of the conveying path 56), and a second control panel 94 mounted on the second end 18b of the storage unit 18. The first control panel 90 includes a button 96. The second control panel 94 includes a display 98 in the form of a screen.

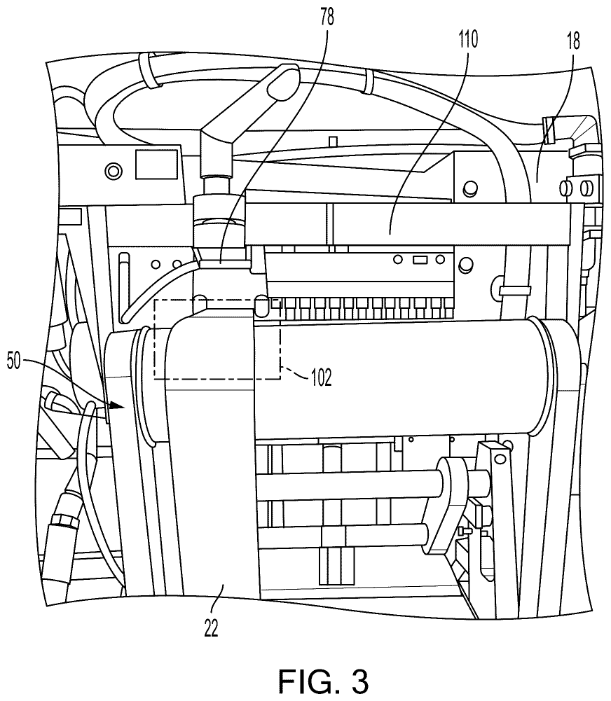

Turning to FIG. 3, the joining device 50 of the storage unit 18 is illustrated in more detail. The sensor 78 is arranged on the joining device 50 and is configured to detect the presence of label material 22 within a detection zone 102. The detection zone 102 is downstream of the splice zone 106 (FIG. 1) in which the splicing operation occurs. The sensor 78 is supported above the detection zone 102 by a bracket 110. The sensor 78 may be a visual sensor that utilizes visual input to determine the presence of label material 22. In the illustrated embodiment, the sensor 78 is a photo-electric sensor. In some embodiments, the control system 74 may determine the presence of label material 22 by comparing current visual data obtained by the sensor 78 to previous visual data obtained by the sensor 78 (e.g., may monitor for a change in the signal received from the sensor 78). In some embodiments, the control system 74 may compare current visual data obtained by the sensor 78 to reference data stored in a memory of the control system 74. When the sensor 78 indicates that no label material 22 is in the detection zone 102, the control system 74 triggers a fault condition of the labelling system 10. In some embodiments, the sensor 78 may be calibrated before each operation of the labelling system based on the pattern of the label material 22. In some embodiments, the sensor 78 may be slidable along the bracket 110 to be best positioned above the label material 22 based on the width of the label material 22.

Referring to FIGS. 4-7, the clamping device 82 is arranged between joining device 50 and the buffering device 26 and selectively clamps the label material 22 traveling through the labelling system 10 to prevent movement of the label material 22 along the conveying path 56. In the illustrated embodiment, the clamping device 82 is positioned on the first end 18a of the storage unit 18 adjacent the exit portion 54 of the conveying path 56. Thus, the clamping device 82 is arranged downstream of the joining device 50 and is arranged upstream of the buffering device 26 and the label applicator 30. The clamping device 82 includes a bracket 118 defining a channel 122, a clamp assembly 126 positioned within the channel 122, and an actuator 130.

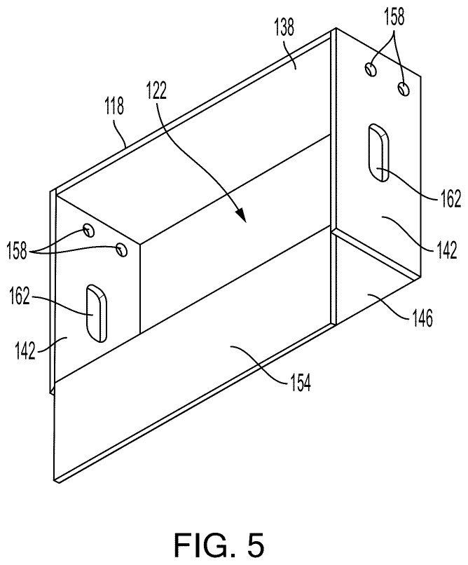

With reference to FIG. 5, the bracket 118 includes a top bar 138, a pair of side plates 142, and a bottom plate 146 cooperating to define the channel 122. A flange 154 extends downward from the bottom plate 146. The pair of side plates 142 each include a pair of first openings 158 and a slot 162.

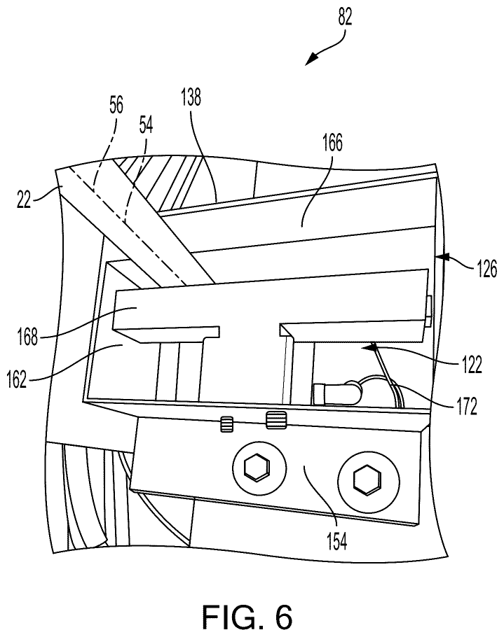

As seen in FIGS. 4 and 6, the bracket 118 is mounted to the storage unit 18 by the flange 154 so that the channel 122 is aligned with the exit portion 54 of the conveying path 56 of the label material 22. Thus, the conveying path 56 of the label material 22 passes through the channel 122.

With reference to FIG. 6, the clamp assembly 126 is mounted in the channel 122. The clamp assembly 126 includes an upper clamp bar 166 and a lower clamp bar 168. The upper clamp bar 166 is secured to the bracket 118 adjacent the top bar 138 by fasteners that extend through the pair of first openings 158 in each side plate 142. The lower clamp bar 168 is movably connected to the bracket 118 by fasteners extending through the slots 162 of each side plate 142. The lower clamp bar 168 is movable between an unclamped position and a clamped position. The lower clamp bar 168 moves generally linearly between the unclamped position and clamped position in a direction generally transverse to the exit portion 54 of the conveying path 56, as the fasteners slide within the slots 162. In the clamped position, the lower clamp bar 168 is moved into engagement with the upper clamp bar 166, blocking the exit portion 54 of the conveying path 56 and pressing the label material 22 therebetween. In some embodiments, the upper clamp bar 166 and lower clamp bar 168 may each include a rubber gasket or other deformable member to increase the grip of the clamp assembly 126 on the label material 22.

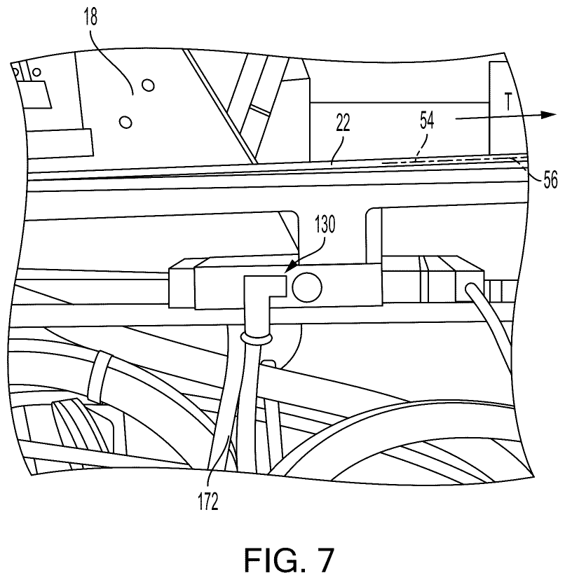

With reference to FIGS. 6 and 7, the actuator 130 is operably coupled to the lower clamp bar 168 and moves the lower clamp bar 168 between the clamped and unclamped positions. In some embodiments, the actuator 130 may be an electronic actuator, a hydraulic actuator, a pneumatic actuator, or a combination thereof. In the illustrated embodiment, the actuator 130 is a solenoid valve assembly mounted on the storage unit 18 and connected to the lower clamp bar 168 by hoses 172. The actuator 130 is controlled by the control system 74 and can be activated to move the lower clamp bar 168 upwards, or deactivated to move the lower clamp bar 168 downwards. Thus, activation of the actuator 130 causes the clamp assembly 126 to clamp the label material 22 and prevent the label material 22 from moving along the conveying path 56. In the illustrated embodiment, the actuator 130 is a solenoid valve coupled to a source of compressed air. The hoses 172 are pneumatic hoses fluidly connecting the actuator 130 to a pneumatic actuator (e.g., a pneumatic rod cylinder; not shown) connected to the lower clamp bar 168.

In normal operation, the storage unit 18 unwinds the label material 22 from one of the reels 42 until a tail end of the label material 22 on the reel 42 is reached. The joining device 50 then performs a splicing operation to connect the tail end of the label material 22 with the front end of label material 22 of the next reel 42. The splicing operation occurs in the splice zone 106, and from there, the newly spliced portion of the label material 22 proceeds through the detection zone 102 and out the storage unit 18 along the exit portion 54. The actuator 130 remains in the deactivated state and the clamp assembly 126 remains open, allowing label material 22 to pass through the channel 122. The label material 22 is then conveyed along the conveying path 56 through the buffering device 26 and supplied to the label applicator 30.

During operation, a failed splice may occur when the tail end of the label material 22 from one reel 42 fails to securely connect to the front end of the label material 22 from the next reel 42. More specifically, the storage unit 18 unwinds the label material 22 from one of the reels 42 until a tail end is reached. The joining device 50 attempts to connect the tail end of the label material 22 from the reel 42 to the front end of the label material 22 from the next reel 42 in the splice zone 106, but the connection is not secure or otherwise fails. The loose tail end of the label material 22 is then conveyed out of the splice zone 106 while the front end of the label material 22 of the next reel 42 remains in the splice zone 106. The tail end of the label material 22 passes through the detection zone 102 and under the bracket 110 holding the sensor 78. The sensor 78 detects the absence of the label material 22 in the detection zone 102 and sends a signal to the control system 74, which determines a fault condition (e.g., ‘label break’ or ‘failed splice’) based on the signal.

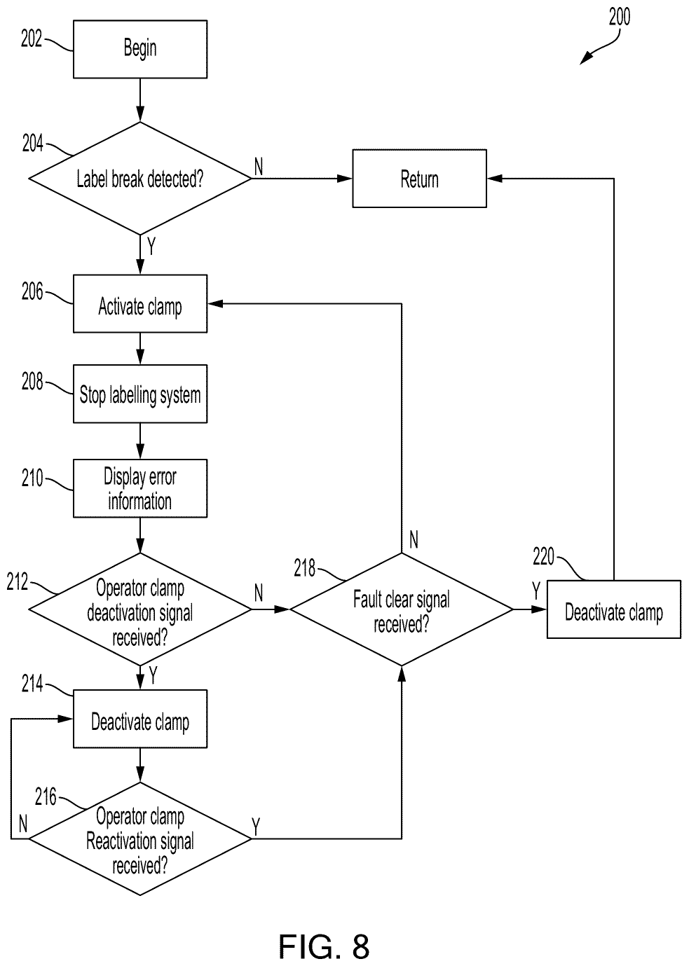

FIG. 8 includes an exemplary flow chart illustrating a method 200 of operation of the fault detection system 70. The method begins at step 202 when, e.g., the labelling system 10 begins operation or the fault detection system 70 is otherwise activated. The clamp assembly 126 begins in an unclamped position at step 202. At step 204, the control system 74 determines whether a fault condition has occurred (e.g., a label break) based on a signal from the sensor 78. If no fault condition is detected, then no action is taken and the clamp assembly 126 remains in the unclamped position. If, at step 204, a fault condition is detected, then the control system 74 sends a signal to the actuator 130, causing the actuator 130 to activate such that the lower clamp bar 168 moves into engagement with the upper clamp bar 166 (i.e., to the clamped position) (step 206). In the clamped position, the clamp assembly 126 clamps or firmly holds the label material 22 between the upper and lower clamp bars 166, 168. The label material 22 is therefore prevented from being conveyed along the conveying path 56. Thus, tension of the label material 22 is held downstream of the clamping device 82, and the label material 22 remains correctly wound around each component along the rest of the conveying path 56 (e.g., the primary roller 58 and the reversing shafts 62, 66 of the buffering device 26, the label applicator 30, etc.). The tail end of the label material 22 remains positioned within the storage unit 18, downstream of the joining device 50 and upstream of the clamping device 82.

If the failed splice occurs when the joining device 50 is near the first end 18a of the storage unit 18, less label material 22 may be positioned upstream of the clamping device 82, and the fault detection system 70 may have relatively less time to detect and respond to a failed splice or a break in the label material 22 before the tail end of the label material 22 exits the storage unit 18. If the failed splice occurs while the joining device 50 is near the second end 18b of the storage unit 18, more label material 22 may be positioned upstream of the clamping device 82, and the fault detection system 70 may have relatively more time to detect and respond to a failed splice or a break before the tail end of the label material 22 exits the storage unit 18. The fault detection system 70 is calibrated based on the amount of time allowed at the first end 18a, and the fault detection system 70 is able to actuate the clamping device 82 before the tail end of the label material 22 moves downstream of the clamping device 82, regardless of the location of the joining device 50.

In some embodiments, the control system 74 also sends a signal to stop operation of the labelling system 10 (step 208). In the same or other embodiments, the labelling system 10 may continue to operate in a limited capacity or for a limited period of time after the fault detection system 70 detects a failed splice or a break and activates the clamping device 82. For example, the label material 22 may continue to be supplied to the label applicator 30 as the labelling system 10 winds down to a stop by adjusting the length of label material 22 stored in the buffering device 26. In some embodiments, the labelling system 10 is stopped simultaneously with the engagement of the clamping device 82 and no wind down time is needed. In some embodiments, operation of the labelling system 10 is stopped by other means (e.g., tension in the label material, a separate jam detector, etc.)

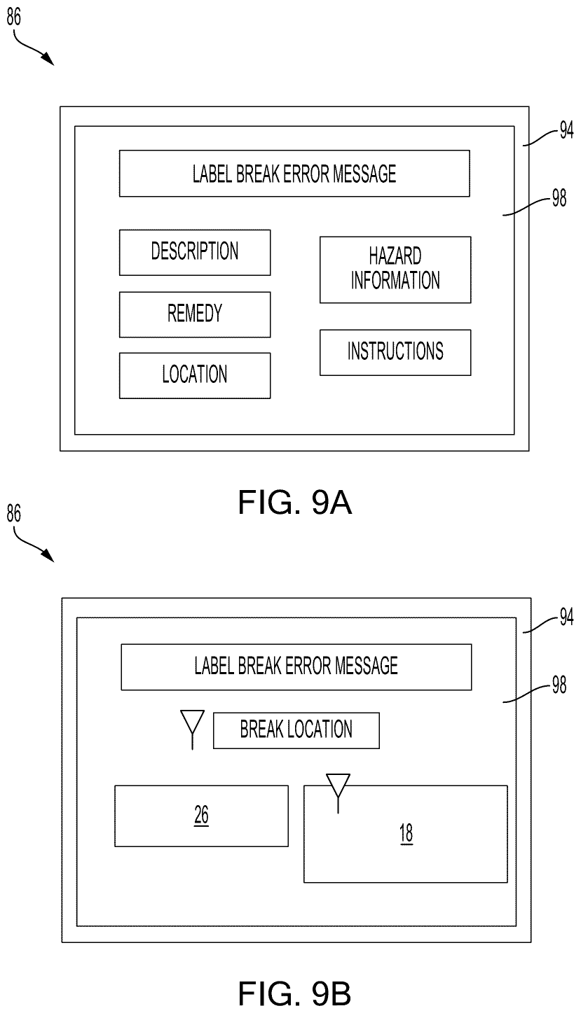

The control system 74 sends information about the fault condition to the display 98 of the second control panel 94 (step 210). Portions of an exemplary screen of the display 98 are shown in FIGS. 9A and 9B. In some embodiments, the information may include a position of the joining device 50 in the storage unit 18, or a number associated with a reel 42 which failed to splice. The information may also include instructions for how to reset the fault detection system 70. In other embodiments, alternate or additional information may be provided.

Referring again to FIGS. 1 and 8, once the labelling system 10 has stopped, the control system 74 determines whether an operator clamp deactivation signal has been received (step 212). For example, the operator may press and hold the button 96 on the first control panel 90 to send the operator clamp deactivation signal to the control system 74. Upon detecting the signal, the control system 74 deactivates the actuator 130 so that the clamp assembly 126 moves to the unclamped position and releases the label material 22 (step 214).

With the clamp assembly 126 deactivated at step 214, the operator can then open the door 52, allowing access to the inside of the storage unit 18, including the joining device 50, the splice zone 106, and the exit portion 54 of the conveying path 56. The operator securely grabs the tail end of the label material 22 from upstream of the clamping device 82. The label material 22 is then pulled by the operator backwards along the conveying path 56 (e.g., opposite the conveying direction T) until enough of the label material 22 is positioned upstream of the clamping device 82 to rethread the joining device 50. This label material 22 may come from adjusting the length of label material 22 stored in the buffering device 26, so that no backward movement of the label material 22 supplied to the label applicator 30 occurs.

Once a sufficient amount of the label material 22 is obtained, the operator releases the button 96, which sends an operator clamp reactivation signal to the control system 74. At step 216, the control system 74 detects the clamp reactivation signal, and in response, proceeds to step 218. At step 218, the control system 74 determines whether a fault clear signal has been received. If no fault clear signal is detected, then the method 200 returns to step 206 and the control system 74 activates the actuator 130 to move the lower clamp bar 168 upwards into the clamping position, preventing movement of the label material 22 along the conveying path 56 once again. The label material 22 can then be rethreaded through the joining device 50 and the tail end of the label material 22 can be manually connected to the front end of the label material 22 from the next reel 42 (e.g., by tape, adhesive, etc.). The label material 22 is then correctly positioned in the detection zone 102 beneath the sensor 78.

The second control panel 94 may include a reset button (not shown) used to clear the fault. Actuation of the reset button causes the fault clear signal to be sent to the control system 74. In some embodiments, the reset button is on the first control panel 90 instead of the second control panel 94. In some embodiments, the reset button is the same as the button 96 used to hold the clamp open. In some embodiments, the button 96 is used to hold the clamping device 82 open when the door 52 is open and begins a reset process when the door 52 is closed.

Returning to step 218, if the control system 74 detects the fault clear signal (e.g., in response to the reset button being actuated), the control system 74 then deactivates the clamp assembly 126 (step 220). Specifically, the control system 74 deactivates the actuator 130, unclamping the clamp assembly 126 so the label material 22 is released and is free to move along the conveying path 56 in the conveying direction T once more. The method 200 then returns to step 204 and the control system 74 continues to monitor for another label break. The labelling system 10 can then restart operation. In some embodiments, between step 218 and step 220, the control system 74 may perform an additional step to evaluate input from the sensor 78, detect whether there is label material 22 in the detection zone 102, and if so, then proceed to step 220. In some embodiments, the control system 74 automatically signals for operation of the labelling system 10 to resume after step 220. In other embodiments, an operator may resume operation of the labelling system 10 through the user interface 86.

Returning to step 212, in some instances, the operator may successfully repair the label break without needing to temporarily release the clamp assembly 126 via the release button. In these instances, at step 212, the control system 74 does not receive the operator clamp deactivation signal and the method 200 proceeds directly to step 218.

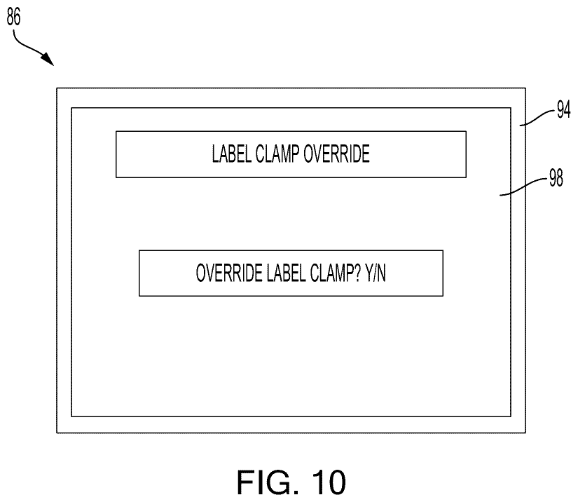

The user interface 86 may include an override setting which instructs the control system 74 to disregard input from the sensor 78 and keep the actuator 130 deactivated. For example, FIG. 10 illustrates an exemplary portion of the screen of the display 98 that includes an override setting.

The fault detection system 70 of the illustrated labelling system 10 improves efficiency of the labelling system 10 in the event of a failed splice or break by reducing downtime and simplifying the reset process the labelling system 10.

Accordingly, the systems, methods, and embodiments described in the examples above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention. Various features and advantages of the invention are set forth in the following claims.

What is claimed is:

1. A storage unit for a labelling system, the labelling system configured to move a label material along a conveying path and apply the label material to a plurality of bottles, the storage unit comprising:
a carrier configured to receive a reel supporting the label material; and
a fault detection system configured to selectively prevent the label material from travelling along the conveying path, the fault detection system including:
a sensor configured to detect whether the label material is present in a detection zone of the conveying path; and
a clamp assembly downstream of the sensor along the conveying path, the clamp assembly being configured to clamp the label material to prevent the label material from travelling along the conveying path in response to the sensor detecting that the label material is not present in the detection zone.

2. The storage unit of claim 1, wherein:
the carrier is a first carrier and the reel is a first reel, and the storage unit further comprises a second carrier configured to receive a second reel supporting the label material;
the storage unit further comprises a joining device configured to couple the label material of the first reel to the label material of the second reel.

3. The storage unit of claim 2, wherein the sensor is positioned adjacent the joining device.

4. The storage unit of claim 2, wherein a broken end of the label material is formed in response to the joining device failing to couple the label material of the first reel to the label material of the second reel, and wherein the clamp assembly is configured to clamp the label material before the broken end exits the storage unit along the conveying path.

5. The storage unit of claim 1, wherein the clamp assembly includes a first clamp bar arranged in facing relationship with a second clamp bar, and wherein the first clamp bar is configured to move between a clamped position proximate the second clamp bar and an unclamped position distant from the second clamp bar.

6. The storage unit of claim 5, wherein the clamp assembly further includes an actuator configured to move the first clamp bar between the clamped position and the unclamped position.

7. The storage unit of claim 6, wherein the actuator includes a solenoid valve assembly.

8. A fault detection system for a labelling system, the labelling system including a storage unit, a buffering device, and a label applicator, the labelling system being configured to move a label material along a conveying path from the storage unit through the buffering device and to the label applicator, the label applicator being configured to apply the label material to a plurality of containers, the storage unit including a first carrier configured to receive a first reel supporting the label material, a second carrier configured to receive a second reel supporting the label material, and a joining device configured to couple the label material of the first reel to the label material of the second reel, the fault detection system comprising:
a sensor configured to detect whether the label material is present in a detection zone of the conveying path; and
a clamp assembly configured to clamp the label material to prevent the label material from travelling along the conveying path in response to the sensor detecting that the label material is not present in the detection zone of the conveying path.

9. The fault detection system of claim 8, wherein the sensor is configured to be positioned adjacent the joining device.

10. The fault detection system of claim 8, wherein the clamp assembly includes a first clamp bar arranged in facing relationship with a second clamp bar, and wherein the first clamp bar is configured to move between a clamped position proximate the second clamp bar and an unclamped position distant from the second clamp bar.

11. The fault detection system of claim 10, wherein the clamp assembly further includes a bracket configured to support the first clamp bar and the second clamp bar on the storage unit.

12. The fault detection system of claim 10, wherein the clamp assembly further includes an actuator configured to move the first clamp bar between the clamped position and the unclamped position.

13. The fault detection system of claim 12, wherein the actuator includes a solenoid valve assembly.

14. A method of operating a labeling system configured to apply label material to containers, the method comprising:
moving a label material along a conveying path from a storage unit, through a buffering device, and to a label applicator;
applying the label material to the containers via the label applicator;
detecting, via a sensor, whether the label material is present in a detection zone of the conveying path; and
clamping, via a clamp assembly, the label material at a location downstream from the detection zone along the conveying path in response to detecting that the label material is not present in the detection zone.

15. The method of claim 14, further comprising deactivating the label applicator in response to detecting that the label material is not present in the detection zone.

16. The method of claim 15, further comprising releasing the label material from the clamp assembly in response to an operator generated deactivation signal.

17. The method of claim 16, further comprising:
attaching a first free end of the label material to a second free end of the label material while the clamp assembly remains released and the label applicator remains deactivated; and
clamping the label material via the clamp assembly in response to an operator generated reactivation signal.

18. The method of claim 15, further comprising releasing the label material from the clamp assembly in response to a fault clear signal.

19. The method of claim 18, further comprising reactivating the label applicator in response to the fault clear signal.

20. The method of claim 14, further comprising joining, via a joining device, the label material supplied from a first reel to the label material supplied from a second reel.
